(19) United States
(12) Patent Application Publication
(10) Pub. No.: US 2008/0044220 A1
(43) Pub. Date: Feb. 21, 2008

(54) Fluid applying pen

(75) Inventor: Chun-Hsiung Hsieh, Taipei City (TW)

Correspondence Address: BRUCE H. TROXELL;SUITE 1404, 5205 LEESBURG PIKE, FALLS CHURCH, VA, 22041, US

(73) Assignee: Ausley International co., Ltd.

(21) Appl. No.: 11/506,797

(22) Filed: Aug. 21, 2006

(51) Int. Cl. B43K 1/06; B43M 11/06; A46B 11/04

(52) U.S. Cl. 401/265; 401/263; 401/273

(57) ABSTRACT

A fluid applying pen, the pen mainly has therein a hollow main pipe for receiving fluid material, the upper end of the main pipe is connected and communicated with a silicone head with a bevel surface having spines, while the lower end of the main pipe is connected with a pusher mechanism; the pusher mechanism has a rotation knob provided over the lower end of the hollow main pipe; when the rotation knob is rotated relatively to the main pipe, a pusher rod of the pusher mechanism extending into the main pipe may move a pusher annulus linearly along the wall of the main pipe, so that the fluid will flow out of an opening provided on the silicone head. The bevel surface having spines of the silicone head is convenient for contact with a skin, so that the fluid can be uniformly applied on the skin of a user, and meantime an effect of massaging can be obtained.

### BACKGROUND OF THE INVENTION

1. Field of the invention

The present invention relates to an innovation structure of a fluid applying pen, and especially to an applying pen of fluid cosmetics or maintaining commodities.

2. Description of the Prior Art

Cosmetics or maintaining commodities applied on faces or skins are accepted by modern people paying attention to and trying hard for face and reputation. Normal fluid cosmetics or maintaining commodities (such as emulsions) are loaded in bottles, and the fluid material in a bottle is poured on a palm and then is applied on the surface of a face or skin.

Sometimes such applying mode only makes the fluid material stay in the surface of a skin and is unable to make it reach to a deep area. Medicinal fluid (such as therapeutic whelk medicine) for applying on a partial area or some maintaining commodities having larger molecules (such as placenta extract) normally can only effectively reach to a deep area of a skin by massaging; however, their effects are not good by massaging only with fingers, an equipment convenient for carrying and effective for applying is required, and this is the main category to discuss of the present invention.

Conventional lipstick applying pens with the contents therein in the form of fluid are used to provide the fluid contents, the contents are pushed into feeding pipes by pushing of enlarged blocks at ends of guiding strips that are pushed forwards by rotating of rotation knobs, the contents are extruded to brushes for applying the contents, applying and adjusting of the contents are convenient. The conventional lipstick applying pens are only applicable for the lipstick contents rather than for other fluid cosmetics or maintaining commodities.

### SUMMARY OF THE INVENTION

The present invention mainly is to provide a fluid applying pen, the pen mainly has therein a hollow main pipe for receiving the fluid material, the upper end of the main pipe is connected and communicated with a silicone head with a bevel surface having spines, while the lower end of the main pipe is connected with a pusher mechanism; the pusher mechanism has a rotation knob provided over the lower end of the hollow main pipe; when the rotation knob is rotated relatively to the main pipe, a pusher rod of the pusher mechanism extending into the main pipe may move a pusher annulus linearly along the wall of the main pipe, so that the fluid will flow out of an opening provided on the silicone head. The bevel surface having spines of the silicone head is convenient for contact with a skin, so that the fluid can be uniformly applied on the skin of a user, and meantime an effect of massaging can be obtained.

With the design of the bevel surface having spines of the silicone head of the present invention, liquid cosmetics or maintaining commodities can be applied deeply in a skin in a good massaging mode, this particularly suits medicinal maintaining liquid such as for applying maintaining liquid with an effect of eliminating whelks.

The pusher mechanism of the present invention is provided with a quantitative collar to prevent the fluid material from overly large outflow induced by inadvertent operation.

The present invention will be apparent in its structure and operation after reading the detailed description of the preferred embodiment thereof in reference to the accompanying drawings.

### BRIEF DESCRIPTION OF THE DRAWINGS

FIG. 1 is an anatomic perspective view of the present invention;

FIG. 2 is a perspective view of the present invention with a cover thereof taken off;

FIG. 3 is a sectional view showing operation of the present invention.

### DETAILED DESCRIPTION OF THE PREFERRED EMBODIMENT

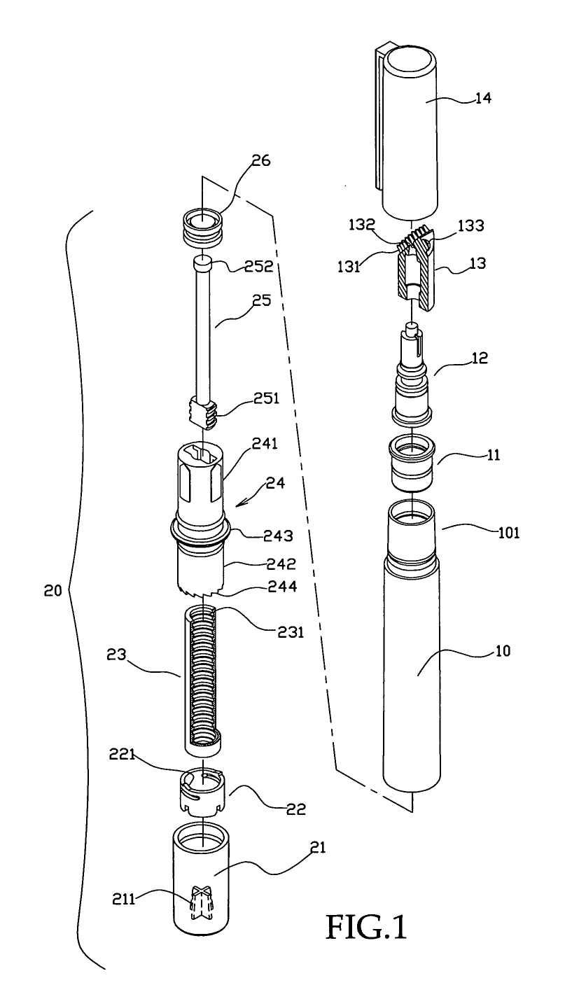

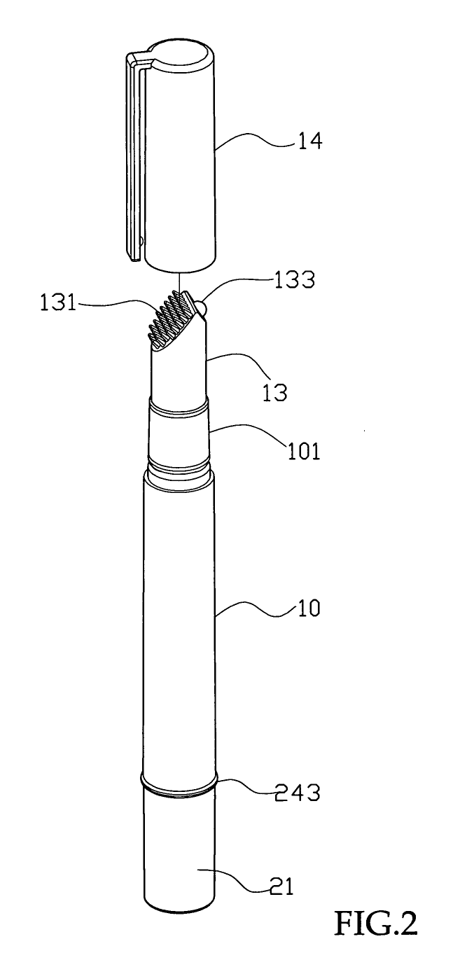

Referring to FIGS. 1-3, the present invention mainly has therein a hollow main pipe 10; the hollow main pipe 10 has therein a storing chamber 102 for receiving the fluid material. The upper end of the main pipe 10 is connected and communicated with a silicone head 13 with a bevel surface 131 having spines via a connecting annulus 11 and a fixing seat 12. The upper end of the main pipe 10 is formed a truncated cone 101 to be slipped into a cover 14 to seal the silicone head 13.

The upper end of the silicone head 13 has the bevel surface 131, and an opening 132 is provided on the bevel surface 131 in communication with the fixing seat 12 slipped into the silicone head 13. By connecting of the connecting annulus 11 with the fixing seat 12 both extending into the main pipe 10, the silicone head 13 is fixed on the upper end of the main pipe 10. The silicone head 13 has on a back side relative to the bevel surface 131 a protrusion 133 which can be used to apply the fluid material or massage the skin of a user.

The lower end of the hollow main pipe 10 is connected with a pusher mechanism 20. The pusher mechanism 20 includes a rotation knob 21, a quantitative collar 22, a threaded pipe 23, a fixing seat 24, a pusher rod 25 and a pusher annulus 26.

The fixing seat 24 is divided into an upper section 241 and a lower section 242 with a flange 243 as a border; the upper section 241 is mounted in a closely fitting mode on the lower end in the main pipe 10, while the lower section 242 is slipped in the rotation knob 21 that can be freely rotated. The lower end of the lower section 242 is a serrated portion 244 engageable with serrations 221 provided on the upper end of the quantitative collar 22 in the rotation knob 21; so that the rotation knob 21 can have a positioning function when it rotates on the lower section 242 of the fixing seat 24 to prevent over rotating of the rotation knob 21.

The fixing seat 24 is provided therein with the threaded pipe 23 having on its inner wall a thread portion 231, and having its lower end slipped over a post 211 in the rotation knob 21 in order that the threaded pipe 23 rotates together with the rotation knob 21.

The pusher rod 25 has on its lower end a bolt 251 in cooperating with the thread portion 231 in the threaded pipe 23, so that when the threaded pipe 23 is moved by the rotation knob 21 to rotate, the pusher rod 25 moves up and down in the main pipe 10. A connecting portion 252 on the upper end of the pusher rod 25 is slipped into the pusher annulus 26, thereby when the pusher rod 25 moves up and down, the pusher annulus 26 will move up and down together with the storing chamber 102 of the hollow main pipe 10 receiving therein the fluid; meantime the pusher annulus 26 forms an effect of piston in the storing chamber 102 to extrude the fluid upwards and make it flow out of the opening 132 provided on the silicone head 13 to the bevel surface 131.

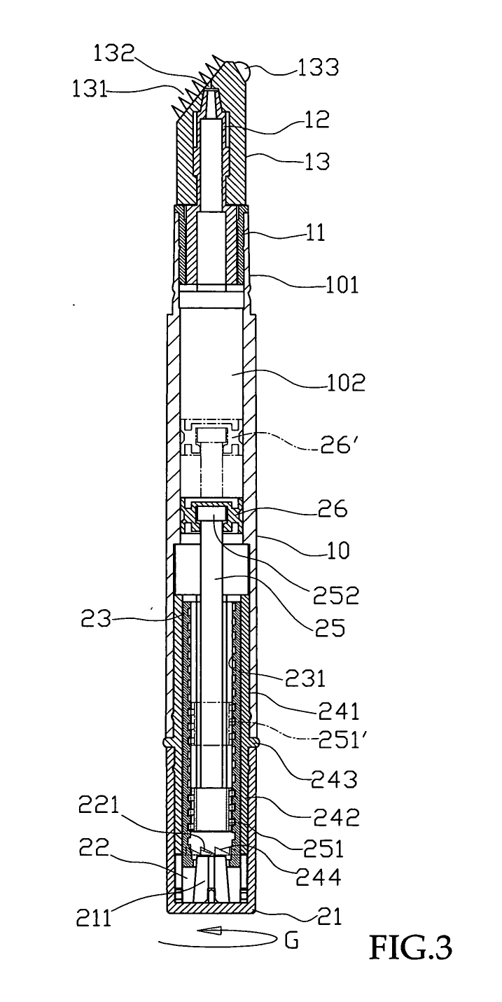

When in use, the cover 14 is removed to expose the silicone head 13, referring to FIG. 3, the drawing is depicted with an arrow G showing rotating of the rotation knob 21, the threaded pipe 23 is rotated therewith; by engagement of the thread portion 231 on the inner wall of the threaded pipe 23 with the bolt 251 of the pusher rod 25, when the threaded pipe 23 is rotated, the bolt 251 is lifted to a position 251′ in the drawing, so that the pusher annulus 26 connected with the upper end of the pusher rod 25 is lifted to a position 26′ in the storing chamber 102 of the hollow main pipe 10 in the drawing, thus the fluid in the storing chamber 102 is pushed to force the fluid to flow toward the silicone head 13, and flow out of the opening 132 on the bevel surface 131 having spines of the silicone head 13.

By contact of the bevel surface 131 having spines with a face of skin, the fluid can be uniformly applied on and enters deeply into the skin of a user.

And more, when the rotation knob 21 is rotated, the serrations 221 provided on the quantitative collar 22 in the rotation knob 21 will engage tooth by tooth with the serrated portion 244 on the lower end of the fixing seat 24, this provides a function of restraining rotation of the rotation knob 21 to not overly rotate to make overly flow of the fluid out of the opening 132 on the silicone head 13.

With the structure of the fluid applying pen of the present invention, applying of fluid cosmetics or maintaining commodities can be easier and more effective, and the designing of the type of the pen has a function of convenient for carrying.

Having thus described the invention, what I claim as new and desire to be secured by Letters Patent of the United States is:

1. A fluid applying pen for applying fluid material on a face or skin, said fluid applying pen comprises:
a hollow main pipe for receiving the fluid material having therein a storing chamber for receiving the fluid material;
a silicone head connected and communicated with an upper end of said hollow main pipe, and having a bevel surface with spines on its upper end, an opening is provided on said bevel surface with said spines, said opening is in communication with said storing chamber; and
a pusher mechanism provided on a lower end of said hollow main pipe, and having at least a rotation knob provided over said lower end of said hollow main pipe;
when said rotation knob is rotated to move said pusher mechanism, said fluid in said storing chamber flows out of said opening of said silicone head to said bevel surface having said spines for applying said fluid.

2. The fluid applying pen as claimed in claim 1, wherein said upper end of said main pipe is formed a truncated cone to be slipped into a cover to seal said silicone head.

3. The fluid applying pen as claimed in claim 1, wherein said silicone head has on a back side relative to said bevel surface a protrusion.

4. The fluid applying pen as claimed in claim 1, wherein a fixing seat is slipped into said silicone head, by connecting of a connecting annulus with said fixing seat both extending into said upper end of said hollow main pipe to connect with said fixing seat, said silicone head is fixed on said upper end of said hollow main pipe.

5. The fluid applying pen as claimed in claim 1, wherein said pusher mechanism has a pusher rod, an upper end of said pusher rod is connected with a pusher annulus extending into said storing chamber of said hollow main pipe, said pusher rod moves linearly in said hollow main pipe when said pusher mechanism moves by rotating of said rotation knob is rotated, and said pusher annulus extrudes said fluid in said storing chamber to make it flow out of said opening provided on said silicone head.

6. The fluid applying pen as claimed in claim 5, wherein said pusher mechanism has a fixing seat fixed in said hollow main pipe, and is provided therein with a threaded pipe having on its inner wall a thread portion, said threaded pipe rotates together with said rotation knob; said pusher rod has on its lower end a bolt in engaging with a thread portion in a threaded pipe, when said threaded pipe is moved by said rotation knob to rotate, said pusher rod moves linearly in said hollow main pipe.

7. The fluid applying pen as claimed in claim 6, wherein said fixing seat is divided into an upper section and a lower section with a flange as a border; said upper section is mounted in a closely fitting mode on said lower end of said hollow main pipe, while said lower section is slipped in said rotation knob.

8. The fluid applying pen as claimed in claim 7, wherein said lower end of said lower section is a serrated portion engaged with serrations provided on said upper end of a quantitative collar in said rotation knob; so that said rotation knob has a positioning function when it rotates on said lower section of said fixing seat.
